(19) United States
(12) Patent Application Publication
(10) Pub. No.: US 2026/0134063 A1
(43) Pub. Date: May 14, 2026

(54) MACHINE LEARNING BASED SYSTEM AND METHOD FOR AUTOMATICALLY GENERATING REGULAR EXPRESSIONS TO IDENTIFY REFERENCES

(71) Applicant: HIGHRADIUS CORPORATION, Houston, TX (US)

(72) Inventors: Bhanuprasad Baddam, Hyderabad (IN); Debanwesh Bose, Hyderabad (IN); Lohit Vankina, Hyderabad (IN); Hashwanth Maripina, Hyderabad (IN); Vipul Jain, Hyderabad (IN); Ansumun Gouda, Hyderabad (IN); Pratyush Amrit, Hyderabad (IN); Aishwarya Kumar, Hyderabad (IN)

(21) Appl. No.: 18/945,805

(22) Filed: Nov. 13, 2024

(51) Int. Cl. G06F 18/241; G06N 20/00

(52) U.S. Cl. CPC G06F 18/241; G06N 20/00

(57) ABSTRACT

A machine learning based (ML-based) system and method for automatically generating regexes to identify references associated with financial documents, is disclosed. Initially, data associated with references are obtained from financial documents. The data are pre-processed to generate pre-processed contents. The pre-processed contents are grouped into clusters, based on similarity of pre-processed contents using a clustering machine learning model. The regexes are generated at a character level for each of the clusters, using a machine learning (ML) model. The regexes are normalized based on at least one of: common patterns in the regexes within each of the clusters and positions of characters in the references within the clusters using threshold values. The regexes obtained after normalizing, are provided as an output, to end users on user interfaces associated with electronic devices associated with the end users.

### FIELD OF INVENTION

Embodiments of the present disclosure relate to machine learning based (ML-based) system and method for automatically generating one or more regular expressions (regexes) to identify one or more references associated with one or more financial documents.

### BACKGROUND

Regular expressions (regex) is a powerful tool for processing financial data, including extracting and validating information from at least one of: invoices, payment details, account numbers, other financial documents, and the like. The processing of the financial data may further include at least one of: extracting invoice numbers, validating payment amounts, identifying account numbers, extracting dates, identifying customer identities, extracting currency amounts, extracting payment references, matching tax identities, and the like.

In the existing method for handling Accounts Receivables (AR), consultants manually create regular expressions (regex) to detect AR references within remittance documents. These references, including at least one of: invoice numbers, document numbers, and purchase order (PO) numbers, are essential for reconciling payments. However, manually developing regex is a labour-intensive process, prone to errors, and demands a thorough knowledge of regex syntax. This method of manual generation of the regular expressions becomes inefficient and unsustainable, particularly when processing a high volume of remittances or dealing with intricate reference formats.

Hence, there is a need for an improved machine learning based (ML-based) system and method for automatically generating one or more regular expressions (regexes) to identify one or more references associated with one or more financial documents, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine-learning based (ML-based) method for automatically generating one or more regular expressions (regexes) to identify one or more references associated with one or more financial documents, is disclosed. The ML-based method comprises obtaining, by one or more hardware processors, data associated with the one or more references from the one or more financial documents.

The ML-based method further comprises pre-processing, by the one or more hardware processors, the data to generate one or more pre-processed contents.

The ML-based method further comprises grouping, by the one or more hardware processors, the one or more pre-processed contents into one or more clusters, based on similarity of the one or more pre-processed contents using a clustering machine learning model.

The ML-based method further comprises generating, by the one or more hardware processors, the one or more regexes at a character level for each of the one or more clusters, using a machine learning (ML) model.

The ML-based method further comprises normalizing, by the one or more hardware processors, the one or more regexes based on at least one of: common patterns in the one or more regexes within each of the one or more clusters and one or more positions of characters in the one or more references within the one or more clusters using one or more threshold values.

The ML-based method further comprises providing, by the one or more hardware processors, the one or more regexes obtained after normalizing, as an output, to one or more end users on one or more user interfaces associated with one or more electronic devices associated with the one or more end users.

In an embodiment, the ML-based method further comprises training, by the one or more hardware processors, the clustering machine learning model for grouping the one or more pre-processed contents into the one or more clusters. Training the clustering machine learning model comprises: (a) obtaining, by the one or more hardware processors, at least one of: one or more numeric values and one or more non-numeric values, of the one or more references; (b) encoding, by the one or more hardware processors, at least one of: the one or more numeric values and the one or more non-numeric values, of the one or more references, into character encoding standard values; (c) training, by the one or more hardware processors, the clustering ML model on the encoded at least one of: the one or more numeric values and the one or more non-numeric values, of the one or more references, to determine the one or more clusters; (d) providing, by the one or more hardware processors, one or more hyperparameters comprising at least one of: n_clusters, metric and linkage; and (e) selecting, by the one or more hardware processors, a hyperparameter from the one or more hyperparameters having best score for tuning the clustering machine learning model.

In another embodiment, generating the one or more regexes at the character level for each of the one or more clusters, using the ML model, comprises: (a) obtaining, by the one or more hardware processors, one or more training datasets comprising one or more historical references as input data and one or more historical regexes as output data; (b) vectorizing, by the one or more hardware processors, the input data and the output data; (c) determining, by the one or more hardware processors, whether at least one of: the one or more alphanumeric references are present as part of the input data, and one or more characters configured to generate the one or more historical regexes, are added to the output data; (d) training, by the one or more hardware processors, the ML model on the input data and the output data using an encoder-decoder machine learning model, wherein the encoder-decoder machine learning model comprises a Long short-term memory (LSTM) layer as an encoder configured to provide encoded data to a decoder of the encoder-decoder machine learning model, wherein the encoded data are obtained by encoding at least one of: the input data and the output data using at least one of: one or more input vocabularies and one or more output vocabularies, wherein the one or more input vocabularies are created using one or more unique characters present in the one or more historical references, and wherein the one or more output vocabularies are created using one or more historical regex, wherein the decoder is configured to decode the encoded data for iteratively generating one or more target sequences of the one or more historical references, offset by one timestep, for training the ML model; and (e) generating, by the one or more hardware processors, the one or more regexes at the character level for each of the one or more clusters using the trained ML model.

In yet another embodiment, normalizing the one or more regexes based on the common patterns in the one or more regexes within each of the one or more clusters, comprises: reducing, by the one or more hardware processors, one to one mapping of the one or more references with the one or more regexes, into many to one mapping of the one or more references with the one or more regexes, for grouping the one or more references belonging to the common patterns in the one or more regexes within each of the one or more clusters.

In yet another embodiment, the one or more threshold values comprises at least one of: (a) a value count threshold to determine a minimum number of occurrences of a specific character at a position, which if exceeded, triggers inclusion of the specific character during normalization of the one or more regexes for the position; and (b) a value coverage threshold to determine a minimum percentage of coverage required for the specific character at the position, which if not met, triggers generalization of the one or more regex for the position.

In yet another embodiment, the ML-based method further comprises validating, by the one or more hardware processors, the one or more regexes on the one or more financial documents using a simulation process. Validating the one or more regexes comprises: (a) obtaining, by the one or more hardware processors, at least one of: one or more image based electronic documents and one or more non-image based electronic documents, from the one or more databases, using simple storage service paths; (b) generating, by the one or more hardware processors, one or more data-interchange formats where a value key is extracted for the one or more image based electronic documents using an optical character recognition engine, wherein the one or more data-interchange formats comprise information extracted by the optical character recognition engine; (c) analyzing, by the one or more hardware processors, one or more text files from the one or more non-image based electronic documents, wherein the information from the one or more non-image based electronic documents is extracted in string format; (d) executing, by the one or more hardware processors, the information extracted from at least one of: the one or more image based electronic documents and the one or more non-image based electronic documents, into a text-based file format comprising at least one of: inbound electronic document header identity and data associated with the one or more electronic documents; (e) extracting, by the one or more hardware processors, data from one or more data fields associated with the one or more electronic documents using the one or more regexes; and (f) categorizing, by the one or more hardware processors, the extracted data with values into at least one of: true positive, false positive, and garbage.

In yet another embodiment, the ML-based method further comprises assessing, by the one or more hardware processors, an accuracy of the one or more regexes by comparing volume of the data associated with the one or more references, identified by the one or more regexes against total volume of available data associated with the one or more references.

In yet another embodiment, the ML-based method further comprises automatically updating, by the one or more hardware processors, the one or more regexes to match one or more patterns of the one or more references. Automatically updating the one or more regexes, comprises: (a) re-generating, by the one or more hardware processors, the one or more regexes based on the one or more patterns of the one or more references, for preceding timelines; (b) re-computing, by the one or more hardware processors, data capture automation metrics for at least one of: the one or more regexes and the one or more re-generated regexes; (c) comparing, by the one or more hardware processors, the data capture automation metrics associated with the one or more regexes and the data capture automation metrics associated with the one or more re-generated regexes, to update the one or more regexes; and (d) providing, by the one or more hardware processors, the updated one or more regexes to the one or more end users for configuring in one or more rules processing modules, based on business thresholds.

In one aspect, a machine learning based (ML-based) system for automatically generating one or more regular expressions (regexes) to identify one or more references associated with one or more financial documents, is disclosed. The ML-based system includes one or more hardware processors and a memory coupled to the one or more hardware processors. The memory includes a plurality of subsystems in the form of programmable instructions executable by the one or more hardware processors.

The plurality of subsystems comprises a data obtaining subsystem configured to obtain data associated with the one or more references from the one or more financial documents.

The plurality of subsystems further comprises a data pre-processing subsystem configured to pre-process the data to generate one or more pre-processed contents.

The plurality of subsystems further comprises a reference grouping subsystem configured to group the one or more pre-processed contents into one or more clusters, based on similarity of the one or more pre-processed contents using a clustering machine learning model.

The plurality of subsystems further comprises a regex generating subsystem configured to generate the one or more regexes at a character level for each of the one or more clusters, using a machine learning (ML) model.

The plurality of subsystems further comprises a regex normalizing subsystem configured to normalize the one or more regexes based on at least one of: common patterns in the one or more regexes within each of the one or more clusters and one or more positions of characters in the one or more references within the one or more clusters using one or more threshold values.

The plurality of subsystems further comprises an output subsystem configured to provide the one or more regexes obtained after normalizing, as an output, to one or more end users on one or more user interfaces associated with one or more electronic devices associated with the one or more end users.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a machine learning based (ML-based) system for automatically generating one or more regular expressions (regexes) to identify one or more references associated with one or more financial documents, in accordance with an embodiment of the present disclosure;

FIG. 2 is a detailed view of the ML-based system for automatically generating the one or more regexes to identify the one or more references associated with the one or more financial documents, in accordance with another embodiment of the present disclosure;

FIG. 3 is an exemplary view depicting grouping of one or more pre-processed contents into one or more clusters, in accordance with another embodiment of the present disclosure;

FIG. 4 is an exemplary tabular view depicting the one or more references in a financial document, in accordance with another embodiment of the present disclosure; and

FIG. 5 is a flow chart illustrating a machine-learning based (ML-based) method for automatically generating the one or more regexes to identify the one or more references associated with the one or more financial documents, in accordance with an embodiment of the present disclosure;

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

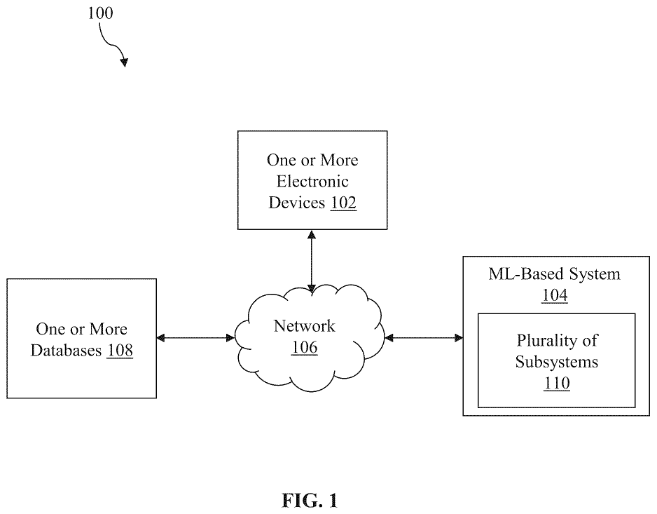

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 is a block diagram illustrating a computing environment 100 with a machine learning based (ML-based) system 104 for automatically generating one or more regular expressions (regexes) to identify one or more references associated with one or more financial documents, in accordance with an embodiment of the present disclosure. According to FIG. 1, the computing environment 100 includes one or more electronic devices 102 that are communicatively coupled to the ML-based system 104 through a network 106. The one or more electronic devices 102 through which one or more end users receive output results from the ML-based system 104.

The present invention is configured to automatically generate the one or more regexes to identify the one or more references associated with the one or more financial documents. The ML-based system 104 is initially configured to obtain data associated with the one or more references from the one or more financial documents. In an embodiment, the data may be encrypted and decrypted by the ML-based system 104, so that one or more third party users cannot be authenticated to manipulate the data.

The ML-based system 104 is further configured to pre-process the data to generate one or more pre-processed contents. The ML-based system 104 is further configured to group the one or more pre-processed contents into one or more clusters, based on similarity of the one or more pre-processed contents using a clustering machine learning model. The ML-based system 104 is further configured to generate the one or more regexes at a character level for each of the one or more clusters, using a machine learning (ML) model.

The ML-based system 104 is further configured to normalize the one or more regexes based on at least one of: common patterns in the one or more regexes within each of the one or more clusters and one or more positions of characters in the one or more references within the one or more clusters using one or more threshold values. The ML-based system 104 is further configured to provide the one or more regexes obtained after normalizing, as an output, to the one or more end users on one or more user interfaces associated with the one or more electronic devices 102 associated with the one or more end users.

In an embodiment, the one or more end users may include at least one of: one or more data analysts, one or more business analysts, one or more cash analysts, one or more financial analysts, one or more collection analysts, one or more debt collectors, one or more professionals associated with cash and collection management, one or more customers, one or more organizations, one or more corporations, one or more parent companies, one or more subsidiaries, one or more joint ventures, one or more partnerships, one or more governmental bodies, one or more associations, and one or more legal entities, and the like.

The ML-based system 104 may be hosted on a central server including at least one of: a cloud server or a remote server. Further, the network 106 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more electronic devices 102 may include at least one of: a laptop computer, a desktop computer, a tablet computer, a Smartphone, a wearable device, a Smart watch, and the like.

Further, the computing environment 100 includes one or more databases 108 communicatively coupled to the ML-based system 104 through the network 106. In an embodiment, the one or more databases 108 may store the one or more financial documents. In an embodiment, the one or more databases 108 includes at least one of: one or more relational databases, one or more object-oriented databases, one or more data warehouses, one or more cloud-based databases, and the like. In another embodiment, a format of the data obtained from the one or more financial documents may include at least one of: a comma-separated values (CSV) format, a JavaScript Object Notation (JSON) format, an Extensible Markup Language (XML), spreadsheets, and the like.

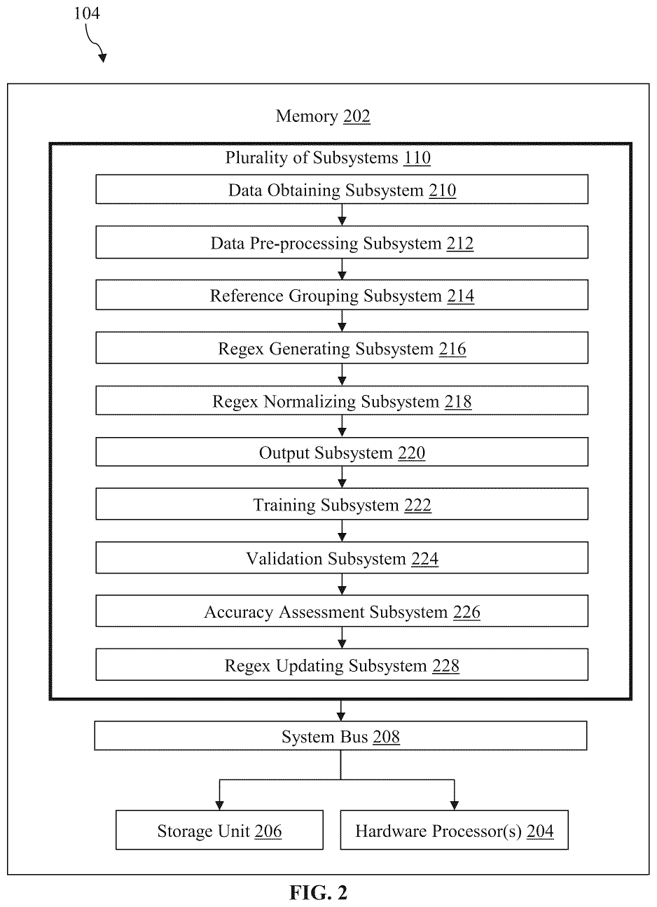

Furthermore, the one or more electronic devices 102 include at least one of: a local browser, a mobile application, and the like. Furthermore, the one or more end users may use a web application through the local browser, the mobile application to communicate with the ML-based system 104. In an embodiment of the present disclosure, the ML-based system 104 includes a plurality of subsystems 110. Details on the plurality of subsystems 110 have been elaborated in subsequent paragraphs of the present description with reference to FIG. 2.

FIG. 2 is a detailed view of the ML-based system 104 for automatically generating the one or more regexes to identify the one or more references associated with the one or more financial documents, in accordance with another embodiment of the present disclosure. The ML-based system 104 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 110 in the form of programmable instructions executable by the one or more hardware processors 204.

The plurality of subsystems 110 includes a data obtaining subsystem 210, a data pre-processing subsystem 212, a reference grouping subsystem 214, a regex generating subsystem 216, a regex normalizing subsystem 218, an output subsystem 220, a training subsystem 222, a validation subsystem 224, an accuracy assessment subsystem 226, and a regex updating subsystem 228. The brief details of the plurality of subsystems 110 have been elaborated in a below table.

| Plurality of | |
|---|---|
| Subsystems | |
| 110 | Functionality |
| Data obtaining | The data obtaining subsystem 210 is configured to |
| subsystem 210 | obtain the data associated with the one or more |
| | references from the one or more financial documents. |
| Data pre- | The data pre-processing subsystem 212 is configured |
| processing | to pre-process the data to generate the one or more |
| subsystem 212 | pre-processed contents. |
| Reference | The reference grouping subsystem 214 is configured |
| grouping | to group the one or more pre-processed contents into |
| subsystem 214 | the one or more clusters, based on the similarity |
| | of the one or more pre-processed contents using |
| | the clustering machine learning model. |
| Regex | The regex generating subsystem 216 is configured |
| generating | to generat ethe one or more regexes at the character |
| subsystem 216 | level for each of the one or more clusters, using |
| | the machine learning (ML) model. |
| Regex | The regex normalizing subsystem 218 is configured to |
| normalizing | normalize the one or more regexes based on at least |
| subsystem 218 | one of: the common patterns in the one or more regexes |
| | within each of the one or more clusters and the one |
| | or more positions of characters in the one or more |
| | references within the one or more clusters using one |
| | or more threshold values. |
| Output | The output subsystem 220 is configured to provide |
| subsystem 220 | the one or more regexes obtained after normalizing, |
| | as an output, to one or more end users on one or |
| | more user interfaces associated with the one or |
| | more electronic devices 102 associated with the |
| | one or more end users. |
| Training | The training subsystem 222 is configured to train |
| subsystem 222 | the clustering machine learning model for grouping the |
| | one or more pre-processed contents into the one or |
| | more clusters. |
| Validation | The validation subsystem 224 is configured to validate |
| subsystem 224 | the one or more regexes on the one or more financial |
| | documents using a simulation process. |
| Accuracy | The accuracy assessment subsystem 226 is configured to |
| assessment | assess an accuracy of the one or more regexes. |
| subsystem 226 | |
| Regex | The regex updating subsystem 228 is configured to |
| updating | automatically update the one or more regexes to |
| subsystem 228 | match one or more patterns of the one or more |
| | references. |

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 110 stored in the form of machine-readable instructions on any of the above-mentioned storage media and may be in communication with and executed by the one or more hardware processors 204.

The storage unit 206 may be a cloud storage, a Structured Query Language (SQL) data store, a noSQL database or a location on a file system directly accessible by the plurality of subsystems 110.

The plurality of subsystems 110 includes the data obtaining subsystem 210 that is communicatively connected to the one or more hardware processors 204. The data obtaining subsystem 210 is configured to obtain the data associated with the one or more references from the one or more financial documents. In an embodiment, the data may include a list of reference numbers (e.g., AR reference numbers) for which the one or more regexes need to be generated. The list of reference numbers or the references may be derived from historical data (e.g., historical AR data).

The usage of the historical data is to ensure that the one or more generated regexes are capable of accurately identifying and matching AR references in future remittances. In an embodiment, the one or more references may include various types of identifiers found in the AR data, including at least one of: document numbers, invoice numbers, PO numbers, and the like. These identifiers are essential for tracking and managing receivables.

The plurality of subsystems 110 includes the data pre-processing subsystem 212 that is communicatively connected to the one or more hardware processors 204. The data pre-processing subsystem 212 is configured to pre-process the data to generate the one or more pre-processed contents. The pre-process of the data is an essential step in data handling involves transforming raw data into a cleaner and more suitable format for sequence processing. During pre-processing, the data (e.g., the AR data) are configured in one or more operations including at least one of: cleaning where errors, inconsistencies, and irrelevant parts of the data are corrected or removed. The data pre-processing may involve a normalizing process to bring the data into a standard format or range.

The structured and cleaned data resulting from the data pre-processing stage, are input for a next step, such as generation of the one or more regexes for identifying the similar AR references in future remittances. The data pre-processing stage may be essential for ensuring the accuracy and efficiency of the subsequent data handling processes. The

The plurality of subsystems 110 includes the reference grouping subsystem 214 that is communicatively connected to the one or more hardware processors 204. The reference grouping subsystem 214 is configured to group the one or more pre-processed contents into the one or more clusters, based on the similarity of the one or more pre-processed contents using the clustering machine learning model. The clustering machine learning model may be an unsupervised machine learning model wherein the data are completely unlabeled and the unsupervised machine learning model is configured to determine one or more hidden patterns in the data. In an embodiment, the clustering machine learning model may include at least one of: K-means clustering machine learning model, Density-Based Spatial Clustering of Applications with Noise (DBSCAN) machine learning model, Affinity propagation machine learning model, Agglomerative Hierarchy clustering machine learning model, and the like.

The present invention utilizes the Agglomerative Hierarchy clustering machine learning model among all the possible clustering machine learning models and the Agglomerative Hierarchy clustering machine learning model provides the best possible clusters. The Agglomerative clustering is a type of a hierarchical clustering model that divides a population into several clusters such that one or more data points in the same cluster are more similar and data points in different clusters are dissimilar.

In other words, for grouping, using the clustering machine learning (ML) model, the one or more references associated with the one or more financial documents, into the one or more clusters, based on the similarity of the one or more references of the one or more account receivables, the reference grouping subsystem 214 is configured to identify the one or more data points associated with the one or more references to group the one or more references into the one or more clusters, using the clustering machine learning (ML) model. In an embodiment, each data point associated with the one or more references in a same cluster is closer to the one or more data points associated with the one or more references in the same cluster. In another embodiment, each data point associated with the one or more references in different clusters is far apart from the one or more data points associated with the one or more references in the different clusters.

The reference grouping subsystem 214 is further configured to group the one or more references based on length of the one or more references (i.e., all the references having identical length, are grouped together). The grouping of the one or more references are used to narrow down the pattern matching, as the one or more reference numbers of different lengths often follow different formats.

The plurality of subsystems 110 further includes the training subsystem 222 that is communicatively connected to the one or more hardware processors 204. The training subsystem 222 is configured to train the clustering machine learning model for grouping the one or more pre-processed contents into the one or more clusters. Training the clustering machine learning model comprises, configuring the training subsystem 222 to obtain at least one of: one or more numeric values and one or more non-numeric values, of the one or more references. The training subsystem 222 is further configured to encode at least one of: the one or more numeric values and the one or more non-numeric values, of the one or more references, into character encoding standard values (e.g., American Standard Code for Information Interchange (ASCII) values). In an embodiment, each character of the one or more references is converted into its equivalent ASCII values. For example, the ASCII value for the reference number “INV-24870” and the encoded reference number is “7378864524870”, where ‘I’ indicates 73, ‘N’ indicates 78, ‘V’ indicates 86, and ‘-’ indicates 45.

The training subsystem 222 is further configured to train the clustering ML model on the encoded at least one of: the one or more numeric values and the one or more non-numeric values, of the one or more references, to determine the one or more clusters. The training subsystem 222 is further configured to provide one or more hyperparameters comprising at least one of: n_clusters being selected based on one or more scores, metric represents ‘Euclidean’, and linkage represents ‘ward’. The training subsystem 222 is further configured to select a hyperparameter from the one or more hyperparameters having best score for tuning the clustering machine learning model.

The plurality of subsystems 110 further includes the regex generating subsystem 216 that is communicatively connected to the one or more hardware processors 204. The regex generating subsystem 216 is configured to generate the one or more regexes at the character level for each of the one or more clusters, using the machine learning (ML) model. The regex generation process is performed as a machine translation process where input data consist of alphanumeric reference numbers and output data are regexes that match the input pattern. To generate the regexes, a character level recurrent sequence to sequence model is trained. The training process may be implemented using existing open-source python libraries.

For generating one or more regexes at the character level for each of the one or more clusters, the regex generating subsystem 216 is configured to obtain one or more training datasets including one or more historical references as the input data and one or more historical regexes as the output data. The regex generating subsystem 216 is further configured to vectorize the input data and the output data. The regex generating subsystem 216 is further configured to determine whether at least one of: the one or more alphanumeric references are present as part of the input data, and one or more characters configured to generate the one or more historical regexes, are added to the output data.

The regex generating subsystem 216 is further configured to train the ML model on the input data and the output data using an encoder-decoder machine learning model. In an embodiment, the encoder-decoder machine learning model includes a Long short-term memory (LSTM) layer as an encoder configured to provide encoded data to a decoder of the encoder-decoder machine learning model. The encoded data are obtained by encoding at least one of: the input data and the output data using at least one of: one or more input vocabularies and one or more output vocabularies. The one or more input vocabularies are created using one or more unique characters present in the one or more historical references. The one or more output vocabularies are created using one or more historical regexes. The decoder is configured to decode the encoded data for iteratively generating one or more target sequences of the one or more historical references, offset by one timestep, for training the ML model. In an embodiment, the decoder is configured to may use initial state vectors as initial state from the encoder. Effectively, the decoder learns to generate targets [t+1 . . . ] given targets[ . . . t], conditioned on the input sequence.

The encoder-decoder machine learning model is configured to generate the one or more regexes for unseen test data once the encoder-decoder machine learning model is trained. The above training and generation steps for data preparation are repeated for test data to be provided as an input to the encoder-decoder machine learning model. The encoder-decoder machine learning model is configured to generate the one or more regexes at the character level for each of the one or more clusters. The output given is one to one mapping between an invoice/reference number and its corresponding generated regex by the encoder-decoder machine learning model.

The plurality of subsystems 110 further includes the regex normalizing subsystem 218 that is communicatively connected to the one or more hardware processors 204. The regex normalizing subsystem 218 is configured to normalize the one or more regexes based on at least one of: common patterns in the one or more regexes within each of the one or more clusters and one or more positions of characters in the one or more references within the one or more clusters using one or more threshold values.

For normalizing the one or more regexes based on the common patterns in the one or more regexes within each of the one or more clusters, the regex normalizing subsystem 218 is configured to divide the data associated with the one or more references into the one or more clusters, to localize the one or more regexes and reduce the number of regexes based on the common patterns in the one or more regexes. The regex normalizing subsystem 218 is further configured to reduce one to one mapping of the one or more references with the one or more regexes, into many to one mapping of the one or more references with the one or more regexes, for grouping the one or more references belong to the common patterns in the one or more regexes within each of the one or more clusters.

In an embodiment, the one or more threshold values may include a value count threshold to determine a minimum number of occurrences of a specific character at a given position, which if exceeded, triggers inclusion of the specific character during normalization of the one or more regexes for the given position. The one or more threshold values may further include a value coverage threshold to determine a minimum percentage of coverage required for the specific character at the given position, which if not met, triggers generalization of the one or more regex for the given position. In an embodiment, the value coverage threshold is an optional threshold needed when the pattern in an account is very generic that may lead to creation of a high amount of specific regexes.

The plurality of subsystems 110 further includes the output subsystem 220 that is communicatively connected to the one or more hardware processors 204. The output subsystem 220 is configured to provide the one or more regexes obtained after normalizing, as an output, to the one or more end users on the one or more user interfaces associated with the one or more electronic devices 102 associated with the one or more end users.

The plurality of subsystems 110 further includes the validation subsystem 224 that is communicatively connected to the one or more hardware processors 204. The validation subsystem 224 is configured to validate the one or more regexes on the one or more financial documents using a simulation process. For validating the one or more regexes, the validation subsystem 224 is configured to obtain at least one of: one or more image based electronic documents and one or more non-image based electronic documents, from the one or more databases 108, using simple storage service (s3) paths. The validation subsystem 224 is further configured to generate one or more data-interchange formats where a value key is extracted for the one or more image based electronic documents using an optical character recognition (OCR) engine, wherein the one or more data-interchange formats (e.g., JavaScript Object Notation (JSON)) include information extracted by the optical character recognition engine.

The validation subsystem 224 is further configured to analyze one or more text files from the one or more non-image based electronic documents. The information from the one or more non-image based electronic documents is extracted in string format. The validation subsystem 224 is further configured to execute the information extracted from at least one of: the one or more image based electronic documents and the one or more non-image based electronic documents, into a text-based file format including at least one of: inbound electronic document header identity and data associated with the one or more electronic documents.

The validation subsystem 224 is further configured to extract data from one or more data fields associated with the one or more electronic documents using the one or more regexes. The validation subsystem 224 is further configured to categorize the extracted data with values into at least one of: true positive, false positive, and garbage. In an embodiment, the true positive is a reference of the one or more accounts receivables being correctly identified using the one or more regexes. The false positive is a reference of the one or more accounts receivables being identified as second reference of the one or more accounts receivables. The garbage is a value captured by the one or more regexes is dissimilar to the reference of the one or more accounts receivables. In an embodiment, the validation is done header wise and automation percentage is computed for every header using the below equation (1). The average of automation percentage of all headers provides the data capture automation percentage for the regexes used.

$$( number of AR References captured by the regexes ) / ( number of AR References actually present in the remittance ) * 100 \qquad Eqn ( 1 )$$

The plurality of subsystems 110 further includes the accuracy assessment subsystem 226 that is communicatively connected to the one or more hardware processors 204. The accuracy assessment subsystem 226 is configured to assess an accuracy of the one or more regexes by comparing volume of the data associated with the one or more references, identified by the one or more regexes against total volume of available data associated with the one or more references. The data capture automation percentage is a key performance indicator in the ML-based system 104. The data capture automation percentage is used to measure current regular expressions (regexes) in capturing relevant data from the remittances.

When the data capture automation percentage for any account falls below a predefined threshold, the data capture automation percentage may signal that the current regexes may not be effectively identifying the data. This may be due to several reasons such as changes in the data format, introduction of new types of data that the current regexes are not configured to identify, or simply that the existing regexes have become outdated. For addressing the above said issues, the ML-based system 104 is configured to automatically generate new regexes. This process is initiated when the data capture automation percentage drops below the set threshold. The generation of new regexes is based on a thorough analysis of the uncaptured data. The ML-based system 104 identifies patterns in the data and formulates new regexes that may capture these patterns.

The plurality of subsystems 110 further includes the regex updating subsystem 228 that is communicatively connected to the one or more hardware processors 204. The regex updating subsystem 228 is configured to automatically update the one or more regexes to match one or more patterns of the one or more references. For automatically updating the one or more regexes, the regex updating subsystem 228 is configured to re-generate the one or more regexes based on the one or more patterns of the one or more references, for preceding timelines (i.e., the process is automated which runs periodically based on configuration, currently period being every month, where the one or more regexes are re-generated for the preceding month).

The regex updating subsystem 228 is further configured to re-compute data capture automation metrics for at least one of: the one or more regexes and the one or more re-generated regexes. The regex updating subsystem 228 is further configured to compare the data capture automation metrics associated with the one or more regexes and the data capture automation metrics associated with the one or more re-generated regexes, to update the one or more regexes. The regex updating subsystem 228 is further configured to provide the updated one or more regexes to the one or more end users for configuring in one or more rules processing modules, based on business thresholds. In an embodiment, the one or more rules processing modules may include a credit authorization and approval rules processing module. The credit authorization and approval rules processing module is used to configure the updated one or more regexes that are provided to the one or more end users (e.g., business stakeholders).

In an embodiment, upon training the ML model, the ML model may be deployed to a cloud production environment. The cloud production environment may be any cloud computing platform, including at least one of: Amazon Web Services (AWS), Microsoft Azure, Google Cloud Platform (GCP), and the like. In an embodiment, the ML model may be deployed to the cloud production environment using any standard ML framework. For example, the ML model may be deployed using TensorFlow, PyTorch, scikit-learn, and the like.

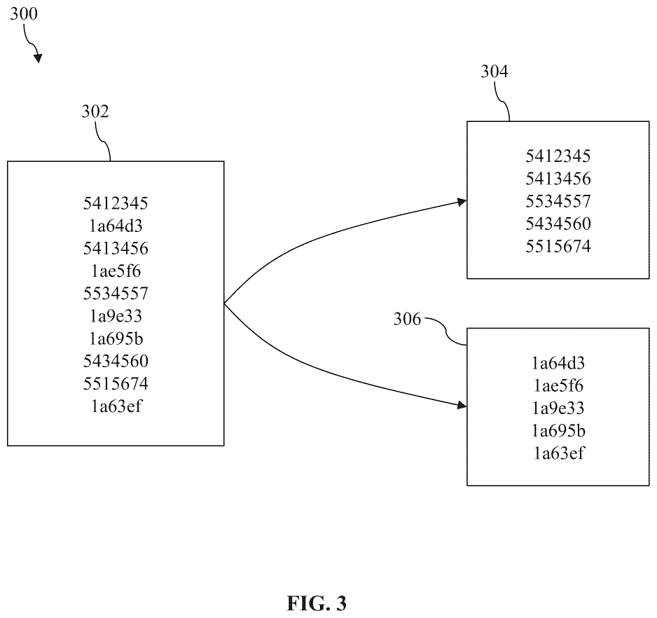

FIG. 3 is an exemplary view 300 depicting grouping of the one or more pre-processed contents into the one or more clusters, in accordance with another embodiment of the present disclosure. FIG. 3 depicts that the one or more pre-processed contents associated with the one or more references 302 are grouped into one or more clusters, based on the similarity of the one or more pre-processed contents using a clustering machine learning model. In an example, the one or more pre-processed contents with references (e.g., “5412345”, “5143456”, and the like) are grouped in one set of clusters 304 based on the similarity of the one or more pre-processed contents using a clustering machine learning model. In another example, the one or more pre-processed contents with references (e.g., “1a64d3”, “1ae5f6”, and the like) are grouped in another set of clusters 306 based on the similarity of the one or more pre-processed contents using a clustering machine learning model.

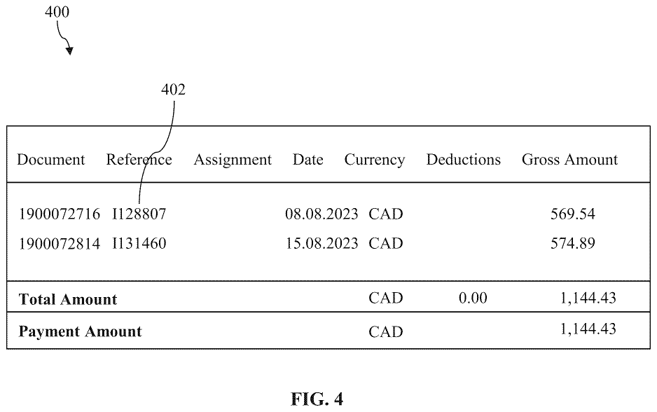

FIG. 4 is an exemplary tabular view 400 depicting a financial document. In an example scenario, the present machine learning (ML) model generates “I1/d{5}” as the regex for the references mentioned in the financial document, then this particular regex is able to identify the references 402 i.e., “I128807” and “I131460” in the financial document.

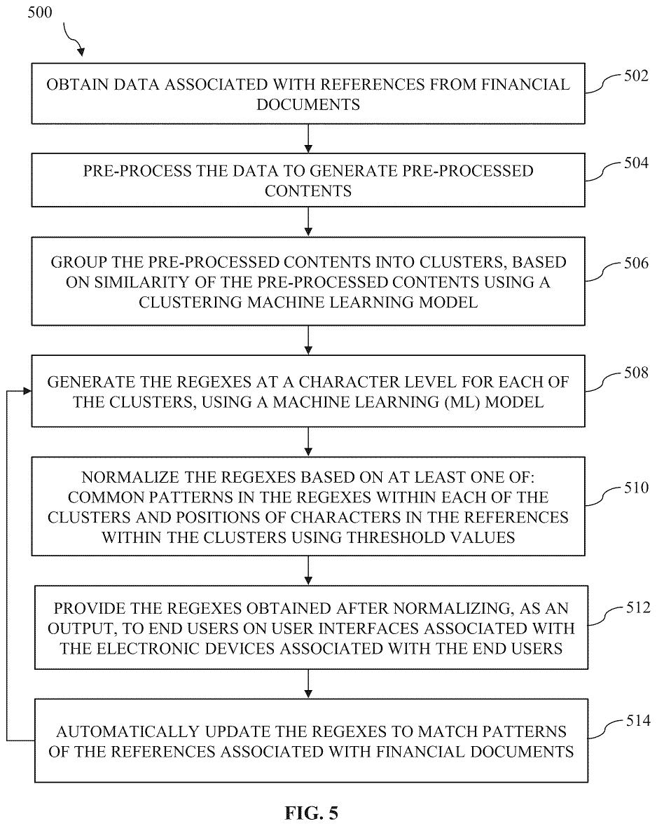

FIG. 5 is a flow chart illustrating a machine-learning based (ML-based) method 500 for automatically generating the one or more regexes to identify the one or more references associated with the one or more financial documents, in accordance with an embodiment of the present disclosure.

At step 502, the data associated with the one or more references are obtained from the one or more financial documents.

At step 504, the data are pre-processed to generate one or more pre-processed contents.

At step 506, the one or more pre-processed contents are grouped into one or more clusters, based on the similarity of the one or more pre-processed contents using the clustering machine learning model.

At step 508, the one or more regexes are generated at the character level for each of the one or more clusters, using the machine learning (ML) model.

At step 510, the one or more regexes are normalized based on at least one of: common patterns in the one or more regexes within each of the one or more clusters and one or more positions of characters in the one or more references within the one or more clusters using one or more threshold values.

At step 512, the one or more regexes obtained after normalizing, are provided as an output, to the one or more end users on the one or more user interfaces associated with the one or more electronic devices 102 associated with the one or more end users.

At step 514, the one or more regexes are automatically updated to match the one or more patterns of the one or more references associated with the one or more financial documents.

The present invention has following advantages. The primary purpose of the present invention with the ML-based system 104 is to generate the one or more regexes for identifying the one or more references (e.g., the AR references), which can enhance efficiency, reduce errors, and streamline the payment closure process. The present invention with the ML-based system 104 is configured to provide flexibility and customization in the regex generation process, as the ML-based system 104 allows the one or more end users to focus on specific types of reference numbers according to their needs. The generated one or more regexes can then be used to streamline the management of receivables by automating the process of identifying and categorizing AR references.

The generation and updation of the one or more regexes by the ML-based system 104, enhances the efficiency of data identification and also reduces the need for manual intervention by the one or more end users in analyzing new patterns proactively and updating the one or more regexes. The present invention ensures that the ML-based system 104 can swiftly adapt to changes in the data and continue to identify relevant data effectively, thereby maintaining a high data capture automation percentage.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the ML-based system 104 either directly or through intervening I/O controllers. Network adapters may also be coupled to the ML-based system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/ML-based system 104 in accordance with the embodiments herein. The ML-based system 104 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the ML-based system 104. The ML-based system 104 can read the inventive instructions on the program storage devices and follow these instructions to execute the methodology of the embodiments herein.

The ML-based system 104 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A machine-learning based (ML-based) method for automatically generating one or more regular expressions (regexes) to identify one or more references associated with one or more financial documents, the ML-based method comprising:
obtaining, by one or more hardware processors, data associated with the one or more references from the one or more financial documents;
pre-processing, by the one or more hardware processors, the data to generate one or more pre-processed contents;
grouping, by the one or more hardware processors, the one or more pre-processed contents into one or more clusters, based on similarity of the one or more pre-processed contents using a clustering machine learning model;
generating, by the one or more hardware processors, the one or more regexes at a character level for each of the one or more clusters, using a machine learning (ML) model;
normalizing, by the one or more hardware processors, the one or more regexes based on at least one of: common patterns in the one or more regexes within each of the one or more clusters and one or more positions of characters in the one or more references within the one or more clusters using one or more threshold values; and
providing, by the one or more hardware processors, the one or more regexes obtained after normalizing, as an output, to one or more end users on one or more user interfaces associated with one or more electronic devices associated with the one or more end users.

2. The machine-learning based (ML-based) method of claim 1, further comprising training, by the one or more hardware processors, the clustering machine learning model for grouping the one or more pre-processed contents into the one or more clusters, wherein training the clustering machine learning model comprises:
obtaining, by the one or more hardware processors, at least one of: one or more numeric values and one or more non-numeric values, of the one or more references;
encoding, by the one or more hardware processors, at least one of: the one or more numeric values and the one or more non-numeric values, of the one or more references, into character encoding standard values;
training, by the one or more hardware processors, the clustering ML model on the encoded at least one of: the one or more numeric values and the one or more non-numeric values, of the one or more references, to determine the one or more clusters;
providing, by the one or more hardware processors, one or more hyperparameters comprising at least one of: n_clusters, metric and linkage; and
selecting, by the one or more hardware processors, a hyperparameter from the one or more hyperparameters having best score for tuning the clustering machine learning model.

3. The machine-learning based (ML-based) method of claim 1, wherein generating the one or more regexes at the character level for each of the one or more clusters, using the ML model, comprises:
obtaining, by the one or more hardware processors, one or more training datasets comprising one or more historical references as input data and one or more historical regexes as output data;
vectorizing, by the one or more hardware processors, the input data and the output data;
determining, by the one or more hardware processors, whether at least one of: the one or more alphanumeric references are present as part of the input data, and one or more characters configured to generate the one or more historical regexes, are added to the output data;
training, by the one or more hardware processors, the ML model on the input data and the output data using an encoder-decoder machine learning model, wherein the encoder-decoder machine learning model comprises a Long short-term memory (LSTM) layer as an encoder configured to provide encoded data to a decoder of the encoder-decoder machine learning model,
wherein the encoded data are obtained by encoding at least one of: the input data and the output data using at least one of: one or more input vocabularies and one or more output vocabularies, wherein the one or more input vocabularies are created using one or more unique characters present in the one or more historical references, and wherein the one or more output vocabularies are created using one or more historical regexes,
wherein the decoder is configured to decode the encoded data for iteratively generating one or more target sequences of the one or more historical references, offset by one timestep, for training the ML model; and
generating, by the one or more hardware processors, the one or more regexes at the character level for each of the one or more clusters using the trained ML model.

4. The machine-learning based (ML-based) method of claim 1, wherein normalizing the one or more regexes based on the common patterns in the one or more regexes within each of the one or more clusters, comprises:
reducing, by the one or more hardware processors, one to one mapping of the one or more references with the one or more regexes, into many to one mapping of the one or more references with the one or more regexes, for grouping the one or more references belong to the common patterns in the one or more regexes within each of the one or more clusters.

5. The machine-learning based (ML-based) method of claim 1, wherein the one or more threshold values comprises at least one of:
a value count threshold to determine a minimum number of occurrences of a specific character at a position, which if exceeded, triggers inclusion of the specific character during normalization of the one or more regexes for the position; and
a value coverage threshold to determine a minimum percentage of coverage required for the specific character at the position, which if not met, triggers generalization of the one or more regex for the position.

6. The machine-learning based (ML-based) method of claim 1, further comprising validating, by the one or more hardware processors, the one or more regexes on the one or more financial documents using a simulation process, wherein validating the one or more regexes comprises:
obtaining, by the one or more hardware processors, at least one of: one or more image based electronic documents and one or more non-image based electronic documents, from the one or more databases, using simple storage service paths;
generating, by the one or more hardware processors, one or more data-interchange formats where a value key is extracted for the one or more image based electronic documents using an optical character recognition engine, wherein the one or more data-interchange formats comprise information extracted by the optical character recognition engine;
analyzing, by the one or more hardware processors, one or more text files from the one or more non-image based electronic documents, wherein the information from the one or more non-image based electronic documents is extracted in string format;
executing, by the one or more hardware processors, the information extracted from at least one of: the one or more image based electronic documents and the one or more non-image based electronic documents, into a text-based file format comprising at least one of: inbound electronic document header identity and data associated with the one or more electronic documents;
extracting, by the one or more hardware processors, data from one or more data fields associated with the one or more electronic documents using the one or more regexes; and
categorizing, by the one or more hardware processors, the extracted data with values into at least one of: true positive, false positive, and garbage.

7. The machine-learning based (ML-based) method of claim 1, further comprising assessing, by the one or more hardware processors, an accuracy of the one or more regexes by comparing volume of the data associated with the one or more references, identified by the one or more regexes against total volume of available data associated with the one or more references.

8. The machine-learning based (ML-based) method of claim 1, further comprising automatically updating, by the one or more hardware processors, the one or more regexes to match one or more patterns of the one or more references, wherein automatically updating the one or more regexes, comprises:
re-generating, by the one or more hardware processors, the one or more regexes based on the one or more patterns of the one or more references, for preceding timelines;
re-computing, by the one or more hardware processors, data capture automation metrics for at least one of: the one or more regexes and the one or more re-generated regexes;
comparing, by the one or more hardware processors, the data capture automation metrics associated with the one or more regexes and the data capture automation metrics associated with the one or more re-generated regexes, to update the one or more regexes; and
providing, by the one or more hardware processors, the updated one or more regexes to the one or more end users for configuring in one or more rules processing modules, based on business thresholds.

9. A machine-learning based (ML-based) system for automatically generating one or more regular expressions (regexes) to identify one or more references associated with one or more financial documents, the ML-based system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a data obtaining subsystem configured to obtain data associated with the one or more references from the one or more financial documents;
a data pre-processing subsystem configured to pre-process the data to generate one or more pre-processed contents;
a reference grouping subsystem configured to group the one or more pre-processed contents into one or more clusters, based on similarity of the one or more pre-processed contents using a clustering machine learning model;
a regex generating subsystem configured to generate the one or more regexes at a character level for each of the one or more clusters, using a machine learning (ML) model;
a regex normalizing subsystem configured to normalize the one or more regexes based on at least one of: common patterns in the one or more regexes within each of the one or more clusters and one or more positions of characters in the one or more references within the one or more clusters using one or more threshold values; and
an output subsystem configured to provide the one or more regexes obtained after normalizing, as an output, to one or more end users on one or more user interfaces associated with one or more electronic devices associated with the one or more end users.

10. The machine-learning based (ML-based) system of claim 9, further comprising a training subsystem configured to train the clustering machine learning model for grouping the one or more pre-processed contents into the one or more clusters, wherein in training the clustering machine learning model comprises, the training subsystem is configured to:
obtain at least one of: one or more numeric values and one or more non-numeric values, of the one or more references;
encode at least one of: the one or more numeric values and the one or more non-numeric values, of the one or more references, into character encoding standard values;
train the clustering ML model on the encoded at least one of: the one or more numeric values and the one or more non-numeric values, of the one or more references, to determine the one or more clusters;
provide one or more hyperparameters comprising at least one of: n_clusters, metric and linkage; and
select a hyperparameter from the one or more hyperparameters having best score for tuning the clustering machine learning model.

11. The machine-learning based (ML-based) system of claim 9, wherein in generating the one or more regexes at the character level for each of the one or more clusters, using the ML model, the regex generating subsystem is configured to:
obtain one or more training datasets comprising one or more historical references as input data and one or more historical regexes as output data;
vectorize the input data and the output data;
determine whether at least one of: the one or more alphanumeric references are present as part of the input data, and one or more characters configured to generate the one or more historical regexes, are added to the output data;
train the ML model on the input data and the output data using an encoder-decoder machine learning model, wherein the encoder-decoder machine learning model comprises a Long short-term memory (LSTM) layer as an encoder configured to provide encoded data to a decoder of the encoder-decoder machine learning model,
wherein the encoded data are obtained by encoding at least one of: the input data and the output data using at least one of: one or more input vocabularies and one or more output vocabularies, wherein the one or more input vocabularies are created using one or more unique characters present in the one or more historical references, and wherein the one or more output vocabularies are created using one or more historical regexes,
wherein the decoder is configured to decode the encoded data for iteratively generating one or more target sequences of the one or more historical references, offset by one timestep, for training the ML model; and
generate the one or more regexes at the character level for each of the one or more clusters using the trained ML model.

12. The machine-learning based (ML-based) system of claim 9, wherein in normalizing the one or more regexes based on the common patterns in the one or more regexes within each of the one or more clusters, the regex normalizing subsystem is configured to:
reduce one to one mapping of the one or more references with the one or more regexes, into many to one mapping of the one or more references with the one or more regexes, for grouping the one or more references belong to the common patterns in the one or more regexes within each of the one or more clusters.

13. The machine-learning based (ML-based) system of claim 9, wherein the one or more threshold values comprises at least one of:
a value count threshold to determine a minimum number of occurrences of a specific character at a position, which if exceeded, triggers inclusion of the specific character during normalization of the one or more regexes for the position; and
a value coverage threshold to determine a minimum percentage of coverage required for the specific character at the position, which if not met, triggers generalization of the one or more regex for the position.

14. The machine-learning based (ML-based) system of claim 9, further comprising a validation subsystem configured to validate the one or more regexes on the one or more financial documents using a simulation process, wherein in validating the one or more regexes, the validation subsystem is configured to:
obtain at least one of: one or more image based electronic documents and one or more non-image based electronic documents, from the one or more databases, using simple storage service paths;
generate one or more data-interchange formats where a value key is extracted for the one or more image based electronic documents using an optical character recognition engine, wherein the one or more data-interchange formats comprise information extracted by the optical character recognition engine;
analyze one or more text files from the one or more non-image based electronic documents, wherein the information from the one or more non-image based electronic documents is extracted in string format;
execute the information extracted from at least one of: the one or more image based electronic documents and the one or more non-image based electronic documents, into a text-based file format comprising at least one of: inbound electronic document header identity and data associated with the one or more electronic documents;
extract data from one or more data fields associated with the one or more electronic documents using the one or more regexes; and
categorize the extracted data with values into at least one of: true positive, false positive, and garbage.

15. The machine-learning based (ML-based) system of claim 9, further comprising an accuracy assessment subsystem configured to assess an accuracy of the one or more regexes by comparing volume of the data associated with the one or more references, identified by the one or more regexes against total volume of available data associated with the one or more references.

16. The machine-learning based (ML-based) system of claim 9, further comprising a regex updating subsystem configured to automatically update the one or more regexes to match one or more patterns of the one or more references, wherein in automatically updating the one or more regexes, the regex updating subsystem is configured to:
re-generate the one or more regexes based on the one or more patterns of the one or more references, for preceding timelines;
re-compute data capture automation metrics for at least one of: the one or more regexes and the one or more re-generated regexes;
compare the data capture automation metrics associated with the one or more regexes and the data capture automation metrics associated with the one or more re-generated regexes, to update the one or more regexes; and
provide the updated one or more regexes to the one or more end users for configuring in credit authorization and approval rules processing module, based on business thresholds.

17. A non-transitory computer-readable storage medium having instructions stored therein that when executed by one or more hardware processors, cause the one or more hardware processors to execute operations of:
obtaining data associated with the one or more references from the one or more financial documents;
pre-processing the data to generate one or more pre-processed contents;
grouping the one or more pre-processed contents into one or more clusters, based on similarity of the one or more pre-processed contents using a clustering machine learning model;
generating the one or more regexes at a character level for each of the one or more clusters, using a machine learning (ML) model;
normalizing the one or more regexes based on at least one of: common patterns in the one or more regexes within each of the one or more clusters and one or more positions of characters in the one or more references within the one or more clusters using one or more threshold values; and
providing the one or more regexes obtained after normalizing, as an output, to one or more end users on one or more user interfaces associated with one or more electronic devices associated with the one or more end users.

18. The non-transitory computer-readable storage medium of claim 17, further comprising training the clustering machine learning model for grouping the one or more pre-processed contents into the one or more clusters, wherein training the clustering machine learning model comprises:
obtaining at least one of: one or more numeric values and one or more non-numeric values, of the one or more references;
encoding at least one of: the one or more numeric values and the one or more non-numeric values, of the one or more references, into character encoding standard values;
training the clustering ML model on the encoded at least one of: the one or more numeric values and the one or more non-numeric values, of the one or more references, to determine the one or more clusters;
providing one or more hyperparameters comprising at least one of: n_clusters, metric and linkage; and
selecting a hyperparameter from the one or more hyperparameters having best score for tuning the clustering machine learning model.

19. The non-transitory computer-readable storage medium of claim 17, wherein generating the one or more regexes at the character level for each of the one or more clusters, using the ML model, comprises:
obtaining one or more training datasets comprising one or more historical references as input data and one or more historical regexes as output data;
vectorizing the input data and the output data;
determining whether at least one of: the one or more alphanumeric references are present as part of the input data, and one or more characters configured to generate the one or more historical regexes, are added to the output data;
training the ML model on the input data and the output data using an encoder-decoder machine learning model, wherein the encoder-decoder machine learning model comprises a Long short-term memory (LSTM) layer as an encoder configured to provide encoded data to a decoder of the encoder-decoder machine learning model,
wherein the encoded data are obtained by encoding at least one of: the input data and the output data using at least one of: one or more input vocabularies and one or more output vocabularies, wherein the one or more input vocabularies are created using one or more unique characters present in the one or more historical references, and wherein the one or more output vocabularies are created using one or more historical regexes,
wherein the decoder is configured to decode the encoded data for iteratively generating one or more target sequences of the one or more historical references, offset by one timestep, for training the ML model; and
generating the one or more regexes at the character level for each of the one or more clusters using the trained ML model.

20. The non-transitory computer-readable storage medium of claim 17, further comprising validating the one or more regexes on the one or more financial documents using a simulation process, wherein validating the one or more regexes comprises:
obtaining at least one of: one or more image based electronic documents and one or more non-image based electronic documents, from the one or more databases, using simple storage service paths;
generating one or more data-interchange formats where a value key is extracted for the one or more image based electronic documents using an optical character recognition engine, wherein the one or more data-interchange formats comprise information extracted by the optical character recognition engine;
analyzing one or more text files from the one or more non-image based electronic documents, wherein the information from the one or more non-image based electronic documents is extracted in string format;
executing the information extracted from at least one of: the one or more image based electronic documents and the one or more non-image based electronic documents, into a text-based file format comprising at least one of: inbound electronic document header identity and data associated with the one or more electronic documents;
extracting data from one or more data fields associated with the one or more electronic documents using the one or more regexes; and
categorizing the extracted data with values into at least one of: true positive, false positive, and garbage.
